(19) United States
(12) Patent Application Publication
(10) Pub. No.: US 2005/0221850 A1
(43) Pub. Date: Oct. 6, 2005

(54) Dynamic identifier allotting method and wireless communications system

(75) Inventor: Susumu Kashiwase, Tokyo (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/093,655

(22) Filed: Mar. 29, 2005

(30) Foreign Application Priority Data
Mar. 31, 2004 (JP) 2004-103444

(51) Int. Cl. H04M 11/04

(52) U.S. Cl. 455/512; 455/507

(57) ABSTRACT

A wireless communications system comprises a control apparatus (AA server) for controlling subscriber information, base stations (BS1, BS2), and mobile stations (MS1, MS2), wherein the control apparatus includes: a controlling unit for controlling priorities corresponding to fixed identifiers of mobile stations; the mobile station includes: a transmitting unit for transmitting the fixed identifier of a mobile station to a target base station, to which the mobile station is connected, when being connected to the base station; and the base station includes: a receiving unit for receiving the fixed identifier of a mobile station from the mobile station; and an allotting unit for allotting an identifier in an area corresponding to the priority of the corresponding mobile station to the mobile station on the basis of the received fixed identifier and control information of the controlling unit.

### PRIORITY CLAIM

Priority is claimed on Japanese Patent Application No. 2004-103444, filed Mar. 31, 2004, the content of which is incorporated herein by reference.

### BACKGROUND OF THE INVENTION

1. Field of the Invention

The present invention relates to a dynamic identifier allotting method for dynamically allotting an identifier, which identifies a terminal, to a mobile station in an area from a base station, and a wireless communications system thereof.

2. Description of Related Art

In wide-area wireless communications such as portable wireless communications represented by a mobile station, especially in cases of a high-rate packet communications system such as an HRPD system and HSDPA system, it is assumed that priority is placed on communications in the forward channel from a base station to a mobile station, and resource allotment in the forward channel is controlled by the mobile station. Also, the HRPD system is based on IS-856 published by the American Telecommunications Industry Association (TIA)). The IS-856 communications system has been known as a developed system of the IS-95 communications system. The IS-95 communications system is the one published by a portable wireless system (mobile telephone) of the CDMA system, which is widely utilized in the North America, Korea, China, Japan, etc., at present. Also, the system is disclosed in Japanese Published Unexamined Patent Application No. 2003-298762 described below.

The IS-856 system, which is developed by adding some technical improvements to the IS-95 system, is a communications system specialized in packet communications.

The concept of TDMA (Time Division Multiple Access) is introduced in the IS-856 system, in which mobile stations are divided slot by slot, without simultaneously transmitting to a plurality of mobile stations after code division, in order to secure a peak communications rate to respective mobile stations. With respect to portions divided slot by slot in TDMA, data to a specified mobile station is divided and simultaneously transmitted by using a plurality of code-divided data channels.

It is assumed that priority of communications is established for respective mobile stations in mobile transmission. In this case, for example, it is possible to establish priority of communications by altering slot-allotting algorithms.

Where communications priority is thus established for respective mobile stations, when communications with a specified mobile station are commenced, an inquiry about the communications priority is made from a base station apparatus, which is in communication with the mobile station, to a control station or a server apparatus. Herein, it is assumed that the mobile station apparatus is moved and the communication is handed off to another base station.

In order to take over the communications priority at the base station to which the communication is handed off, it is necessary to transmit information of the communications priority from a source base station apparatus, from which the communication is handed off, to a target base station apparatus to which the communication is handed off. In this case, it is necessary either to transfer information between the base station apparatuses or for the target base station apparatus to which the communication is handed off to newly make an inquiry about the priority information of the corresponding mobile station to the control station or server apparatus. Accordingly, a problem is brought about, in which not only backbone traffic increases for the base station apparatus but also the processing volume of the base station apparatus increases.

### SUMMARY OF THE INVENTION

The present invention was developed in view of the above-described situations, and it is therefore an object of the invention to provide a mobile communications system which is capable of decreasing negotiations about communications priority of a mobile station between the mobile station and base stations and between base stations, and to provide base stations and mobile stations thereof.

The first aspect of the invention relates to a dynamic identifier allotting method of dynamically allotting an identifier which identifies a terminal to a mobile station in an area from a base station. The dynamic identifier allotting method comprises controlling a priority in advance corresponding to a fixed identifier of a mobile station; receiving a fixed identifier of a mobile station from the mobile station to which an identifier is allotted; determining a priority corresponding to the received fixed identifier; and allotting an identifier corresponding to the priority of the mobile station to the mobile station.

Preferably, the fixed identifier of the mobile station is a terminal identifier depending on a mobile station terminal or a subscriber identifier depending on a subscriber.

The second aspect of the invention relates to a dynamic identifier allotting method of dynamically allotting an identifier which identifies a terminal to a mobile station in an area from a base station. The dynamic identifier allotting method comprises receiving an access request from the mobile station; determining a priority corresponding to the received access request; and allotting an identifier corresponding to the access request to the mobile station.

Preferably, the priority corresponding to the access request depends on an application which a mobile station terminal uses.

The third aspect of the invention relates to a dynamic identifier allotting method of dynamically allotting an identifier which identifies a terminal to a mobile station in an area from at least two base stations. The dynamic identifier allotting method comprises receiving an identifier, which a base station being connected has dynamically allotted to the mobile station, via another base station to which a connection of the mobile station is changed; allotting to the mobile station an identifier having a priority corresponding to a priority held by the identifier; and changing the connection of the mobile station from the base station to another base station.

The fourth aspect of the invention relates to a wireless communications system. The wireless communications system comprises a control apparatus for controlling subscriber information, at least two base stations, and a mobile station, wherein the control apparatus includes a controlling unit for controlling a priority corresponding to a fixed identifier of the mobile station; the mobile station includes a transmitting unit for transmitting the fixed identifier of the mobile station to one of the base stations to which the mobile station is connected; and the base stations include a receiving unit for receiving the fixed identifier of the mobile station from the mobile station; and an allotting unit for allotting to the mobile station an identifier in an area corresponding to the priority of the mobile station based on the received fixed identifier and control information of the controlling unit.

Advantageously, the fixed identifier of the mobile station is a terminal identifier depending on a mobile station terminal or a subscriber identifier depending on a subscriber.

The fifth aspect of the invention relates to a wireless communications system. The wireless communications system comprises at least two base stations; and a mobile station, wherein the mobile station includes a transmitting unit for transmitting information showing contents of an access request to one of the base stations to which the mobile station is connected, when making an access request to the base station; and the base stations include a receiving unit for receiving an access request from a mobile station, and an allotting unit for allotting to the mobile station an identifier in an area corresponding to a priority of the access request based on the information showing contents of the received access request.

Advantageously, the information showing the contents of the access request is information showing an application which a mobile station terminal uses.

The sixth aspect of the invention relates to a wireless communications system. The wireless communications system comprises at least two base stations; and a mobile station, wherein: when the mobile station is changed from a base station being connected thereto to another base station, the mobile station includes a transmitting unit for transmitting an identifier dynamically allotted to the mobile station by the base station being connected thereto to another base station to which the mobile station will be connected; and another base station includes a receiving unit for receiving the identifier, and an allotting unit for allotting to the mobile station an identifier having a priority corresponding to a priority held by the identifier received by the receiving unit.

As described above, according to the invention, it becomes unnecessary to frequently make an inquiry about priority information showing the priorities of communications of a mobile station to an AA server, in which the corresponding priority information is stored, and the data volume between base stations can be reduced.

Further, it is possible to know a MAC-ID at the mobile station side during communications. Therefore, it is possible for a mobile station to know the communications priority of its own station, which is established at the base station side, without carrying out any special process to know the communications priority.

Accordingly, the mobile station is capable of controlling the data volume, which is used in an application, and the data transfer rate in accordance with the communications priority of its own station, wherein convenience of a user can be improved.

### BRIEF DESCRIPTION OF THE DRAWINGS

FIG. 1 is a view showing a structure of a mobile communications system according to an embodiment of the invention;

FIG. 2 is a flow chart showing processing contents of a process for setting priority information when a mobile station commences communications in the mobile communications system according to the embodiment of the invention, which is shown in FIG. 1;

FIG. 3 is a flow chart showing processing contents of a process for setting priority information when a hand-off is carried out in the mobile communications system according to the embodiment of the invention, which is shown in FIG. 1;

FIG. 4 is a descriptive view showing detailed operations when a hand-off is carried out in the mobile communications system according to the embodiment of the invention, which is shown in FIG. 1;

FIG. 5 is a view showing a control sequence when a hand-off is carried out in the mobile communications system shown in FIG. 4;

FIG. 6 is a descriptive view showing operations in a prior art mobile communications system;

FIG. 7 is a descriptive view showing the relationship between MAC-IDs and communications priorities;

FIG. 8 is a block diagram showing a detailed structure of mobile stations;

FIG. 9 is a block diagram showing a detailed structure of base stations; and

FIG. 10 is a block diagram showing a detailed structure of an AA server.

### DETAILED DESCRIPTION OF THE INVENTION

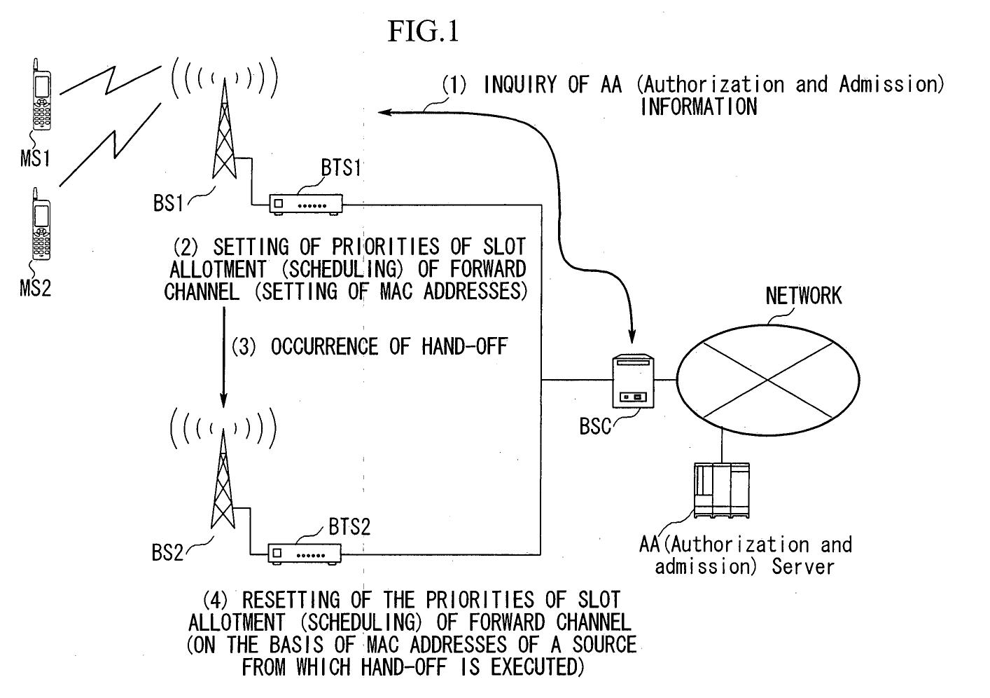

Hereinafter, a detailed description of embodiments of the invention is given with reference to the drawings. FIG. 1 shows a structure of a wireless communications system according to one embodiment of the invention. In the same drawing, the wireless communications system according to the embodiment includes a plurality of mobile stations MS1 and MS2, base stations BS1 and BS2, base station apparatuses BTS1 and BTS2 which are connected to the base stations BS1 and BS2, respectively, a control station BSC, a network connected to the control station BSC, and an AA (authorization and admission) server (hereinafter called an “AA server”) connected to the corresponding network.

The wireless communications system according to the embodiment is a system, in which a downstream wireless channel is divided into slots in a small unit of time, for controlling allotment of the time-divided slots to mobile stations by means of an address number (fixed identifier) contained in a preamble portion prior to the slot, which is to designate to which mobile station under control of a base station a communication is made. The fixed identifier is a MAC-ID in the present embodiment. Also, in fact, there exist a large number of mobile stations, base stations, base station apparatuses and control stations. However, in the present embodiment, only the mobile stations MS1 and MS2, base stations BS1 and BS2, base station apparatuses BTS1 and BTS2 and control station BSC are illustrated.

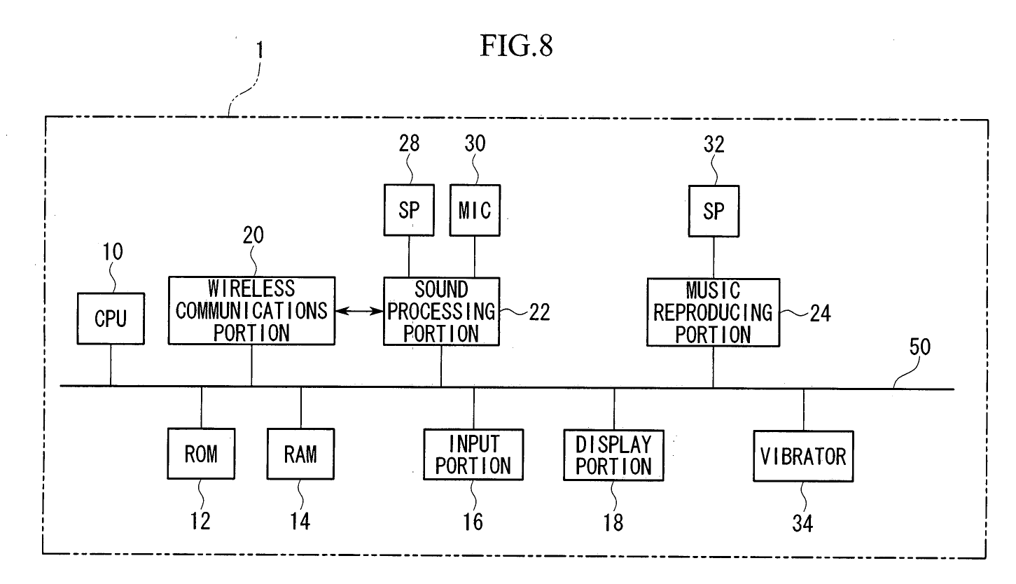

The mobile stations MS1 and MS2 include a telephone feature and a data communications feature. FIG. 8 shows a detailed structure of the mobile stations MS1 and MS2. In FIG. 8, a description is given of a configuration of the mobile stations MS1 and MS2 as a configuration of the mobile station 1. The mobile station 1 shown in FIG. 8 is a block diagram of a portable telephone set operating as a mobile communications terminal device according to the embodiment of the invention, which is shown in FIG. 1. In the same drawing, the mobile telephone set includes: a CPU 10 for controlling movements of the telephone set and various portions operating as exclusive units for various types of applications; a ROM 12 in which various types of programs and fixed data are stored; a RAM 14; an input portion 16; a display portion 18; a wireless communications portion 20; a sound processing portion 22; a music reproducing portion 24; a receiver speaker 28; a microphone 30; an incoming speaker 32; a vibrator 34; and a bus 50.

The wireless communications portion 20 functions as a unit for transmitting a fixed identifier of a mobile station to a target base station, to which the mobile station is connected, when mobile stations MS1 and MS2 are connected to base stations, and a unit for transmitting information showing the contents of an access request to a base station, to which the mobile station is connected, when the mobile station is connected to base stations.

The base stations BS1 and BS2 have a transmitting and receiving feature, and the base station apparatuses BTS1 and BTS2 carry out control to make a connection between mobile stations by means of wireless in accordance with a connection request from a mobile station.

The base station BS1 and base station apparatus BTS1, and base station BS2 and base station apparatus BTS2 correspond to a base station according to the invention, respectively.

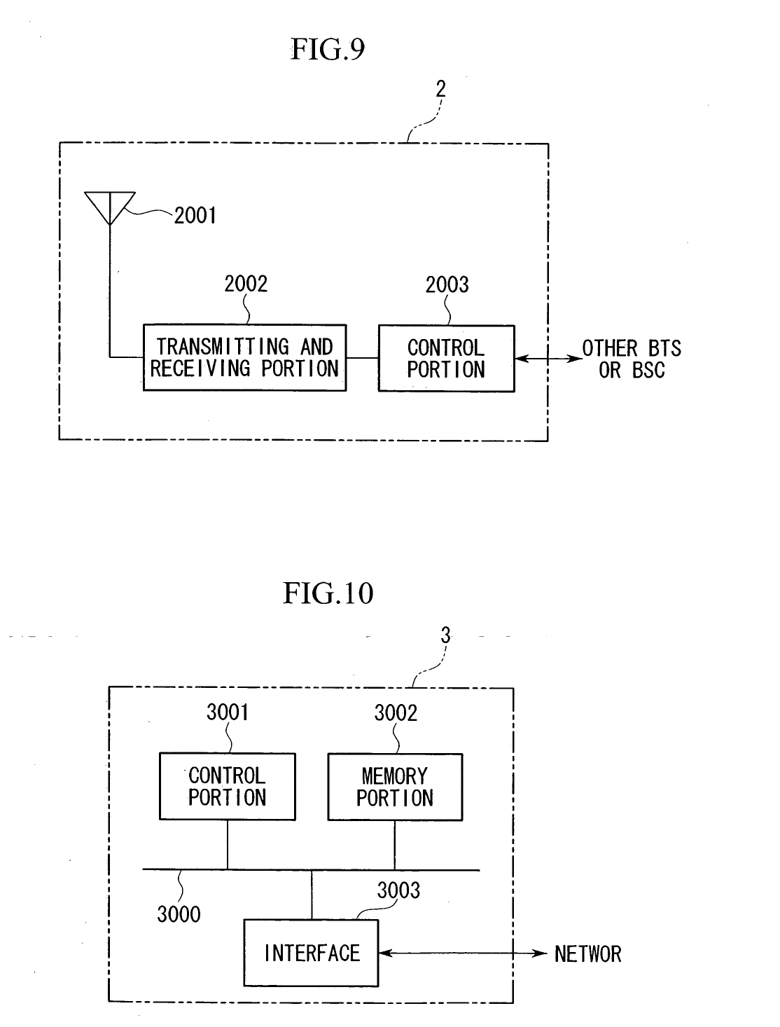

FIG. 9 shows a configuration of a base station 2 consisting of base station BS and base station apparatus BTS. In the same drawing, the base station 2 is provided with an antenna 2001, a transmitting and receiving portion 2002 for making communications with mobile stations by means of the antenna 2001, and a control portion 2003.

The base stations BS1 and BS2 correspond to the antenna 2001 and the transmitting and receiving portion 2002 in FIG. 9, and the control portion 2003 corresponds to the base station apparatus BTS.

The transmitting and receiving portion 2002 corresponds to the receiving means of the present invention, which receives a fixed identifier of a mobile station or an access request from the mobile station.

The control station BSC has a feature of relaying between base stations and the network, and, in detail, has a feature of generally controlling the base station apparatuses BTS1 and BTS2.

An AA server 3 whose configuration is shown in FIG. 10 is provided with a control portion 3001 having a feature of controlling subscriber information of respective mobile stations, a memory portion 3002 in which priority information showing the communications priorities of respective mobile stations is stored, and an interface 3003 for connecting to the network. A control portion 3001, memory portion 3002 and interface 3003 are connected to each other via a bus 3000. The AA server 3 corresponds to the control apparatus of the invention.

The base station apparatuses BTS1 and BTS2 have a feature of allotting a fixed identifier, so that priority of slot allotment is contained in the fixed identifier, on the basis of the priority information of mobile stations, which are acquired from the AA server when allotting a fixed identifier to the mobile stations. That is, the base station apparatuses BTS1 and BTS2 have a feature of allotting an identifier in an area corresponding to the priority of the corresponding mobile station on the basis of the fixed identifier received by the receiving unit and control information of the controlling unit, or a feature of allotting a priority identifier corresponding to the priority held by the identifier received by the receiving unit to the mobile station. The base station apparatuses BTS1 and BTS2 correspond to the allotting unit of the invention.

Further, with respect to a mobile station which commences communications, the base station apparatuses BTS1 and BTS2 have a feature of making an inquiry about priority information of communications of the corresponding mobile station to the AA server and allotting a fixed identifier to the corresponding mobile station, on the basis of the acquired priority information of the corresponding mobile station, so that the priority of slot allotment is contained.

In addition, when a specified mobile station commences communications, the base station apparatuses BTS1 and BTS2 allot a slot to the mobile station based on the priority information of the mobile station, which is acquired from the AA server, and transmit the fixed identifier (MAC-ID) of the mobile station for which a base station, to which the mobile station is handed off, is forced to take over the communications to the base station to which the mobile station is handed off since the base station from which the mobile station is handed off is under control when handing off.

Herein, a description is given of a procedure of allotting a MAC-ID from the base station to the mobile station. With respect to the forward channel from a base station to a mobile station, communications to a specified mobile station in slots of 1.67 ms intervals are allotted in IS-856. The mobile station receives a preamble inserted immediately before the slots, and determines whether or not the slot following the preamble is for communications to its own station.

Mobile stations, which are under communications, simultaneously stored in one base station apparatus are, respectively, identified by numbers called “MAC-ID.” In IS-856, there are sixty-four MAC-IDs. The MAC-ID is transmitted along with a code having an object of synchronizing the timing in the preamble. A mobile station to which a MAC-ID is allotted monitors the MAC-ID in the preamble. Where the MAC-ID in the preamble is made coincident with the MAC-IC allotted to the mobile station, a slot following the preamble is made into an occupancy slot to the mobile station.

It is assumed that communications priorities are established mobile station by mobile station in mobile communications using the IS-856. In this case, the priority may be a priority predetermined in respective mobile stations or may depend on an application which mobile stations use. Herein, the priority depending on the application is a priority corresponding to an access request by a mobile station, and the “access request” corresponds to, for example, “a connection request to the network,” and “a channel allotment request for commencing communications,” etc.

Also, in the present embodiment, although it is intended that priority information showing communications priorities for respective mobile stations is stored in an AA server indirectly connected to the base station apparatuses BTS1 and BTS2 via the control station BSC and network, the priority information may be stored in the control station BSC instead of the AA server. In this case, the control station BSC corresponds to a control apparatus of the present invention.

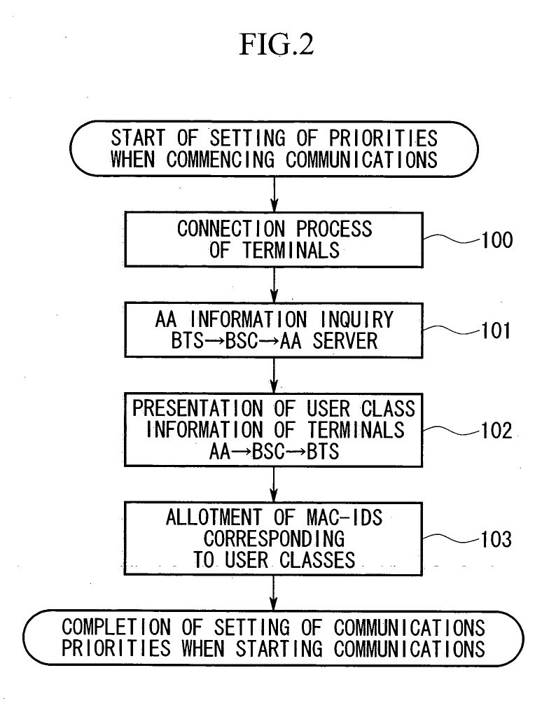

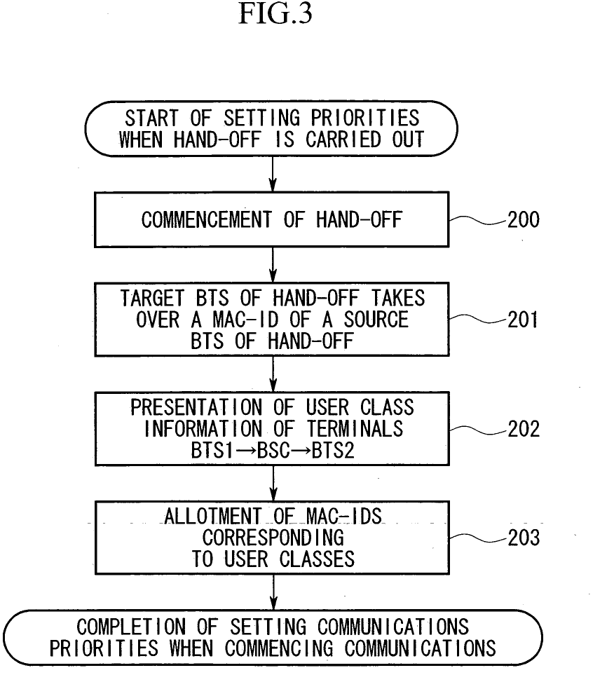

A description is given of actions of a mobile communications system composed of the above construction by reference to flow charts in FIG. 2 and FIG. 3. In the present embodiment, it is assumed that the communications priorities are established for respective mobile stations. FIG. 2 shows processing contents for setting the communications priorities with respect to a mobile station which commences communications.

At present, it is assumed that the mobile stations MS1 and MS2 are positioned in a cell of the base station BS1. In this state, the mobile station MS1 commences communications and carries out a connection process (Step 100). That is, a connection request of the mobile station MS1 is transmitted to the control station BSC via the base station BS1 and base station apparatus BTS1.

The control station BSC makes an inquiry to the AA server about whether or not connection to the mobile station MS1 is enabled. After it is confirmed that the mobile station MS1 is an authentic user, the base station apparatus BTS1 makes an inquiry about the communications priority to the AA server via the control station BSC (Step 101).

Next, the base station apparatus BTS1 acquires the priority information (user class information) established for a mobile station operating as a terminal via the control station BSC from the AA server (Step 102).

The base station apparatus BTS1 allots a MAC-ID, which is an address number, to the mobile station MS1 in accordance with the communications priority shown by the priority information (Step 103). A connection operation is carried out for the mobile station MS2 as well.

Scheduling of communications slots of mobile stations MS1 and MS2 in the base station apparatus BTS1 is carried out by adding the priority information of the mobile stations, which is inquired to the AA server, in addition to the scheduling on the basis of receiving quality, which is usually carried out in IS-856. “Adding the priority information” means, for example, multiplying the parameter of the receiving quality by a parameter of the priority, adding the former to the latter, referencing a table, or inserting a value into a function having a plurality of arguments.

Next, it is assumed that the mobile stations MS1 and MS2 are handed off. Where mobile stations are handed off from the base station apparatus BTS1 to the base station apparatus BTS2, the priority information of the mobile stations MS1 and MS2 to be handed off is transferred from the base station apparatus BTS1 to the base station apparatus BTS2 via the control station BSC. That is, when hand-off is commenced (Step 200), the base station apparatus BTS2 (also called the newly connected base station apparatus) to which a mobile station is handed off takes over the MAC-ID of the mobile stations which are handed off from the base station apparatus BTS1 (Step 201).

Next, the priority information (user class information) established in the mobile stations MS1 and MS2 which are handed off is transmitted from the base station apparatus BTS1 to the base station apparatus BTS2 via the control station BSC (Step 202).

Next, the base station apparatus BTS1 allots MAC-ID, which is an address number to the mobile stations MS1 and MS2 in accordance with the communications priority shown by the above-described priority information (Step 203).

Only by the base station apparatus BTS1 transferring the number of the MAC-ID, which is used for communications between the mobile stations MS1 and MS2, to the base station apparatus BTS2, it is possible for the base station apparatus BTS2 to know the priority information showing the priority of communications between the mobile stations MS1 and MS2 because the MAC-ID and priority information of the mobile stations are made into pairs. After the mobile stations MS1 and MS2 are handed off, the base station apparatus BTS2 carries out scheduling of slots as in the base station apparatus BTS1 and continues the current communications.

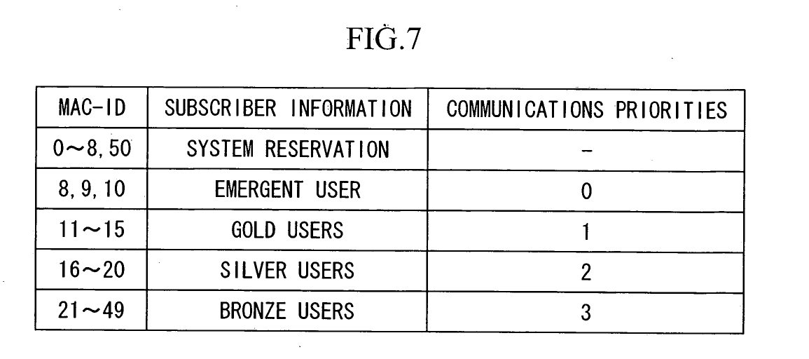

A detailed description is given of the relationship between the MAC-ID and communications priority. FIG. 7 shows the relationship between the MAC-ID and communications priority. As shown in the same drawing, in the present embodiment, the communications priorities are classified into four types which are an emergent user: 1, a gold user: 2, a silver user: 3, and a bronze user: 4, and are thus established.

With respect to the MAC-IDs, 0 through 8 and 50 and over are provided for system reservation, 8, 9 and 10 are allotted for emergent users, 11 through 15 are allotted for gold users, 16 through 20 are allotted for silver users, and 21 through 49 are allotted for bronze users. Where hand-off is performed, usually the same user class is allotted.

The gold users, silver users, and bronze users are determined, for example, on the basis of monthly basis rates.

Where the user class in the base station apparatus to which the mobile stations are handed off is full, a next-grade user class is temporarily allotted. When a regular user class becomes empty, the MAC-ID may be re-allotted thereof. Where the regular class does not become empty and a class down allotment is generated, grade exchange may be carried out between the corresponding mobile station and a mobile station selected at random among mobile stations allotted for the regular class for a specified period of time. The grade exchange may depend on the communications quality of mobile stations and accumulated communications time in addition to the random selection.

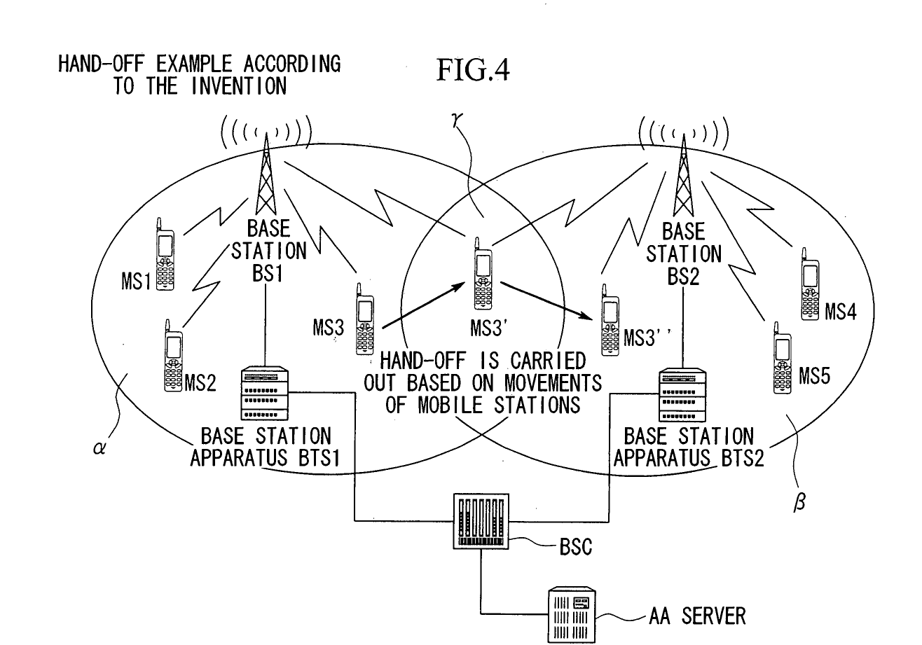

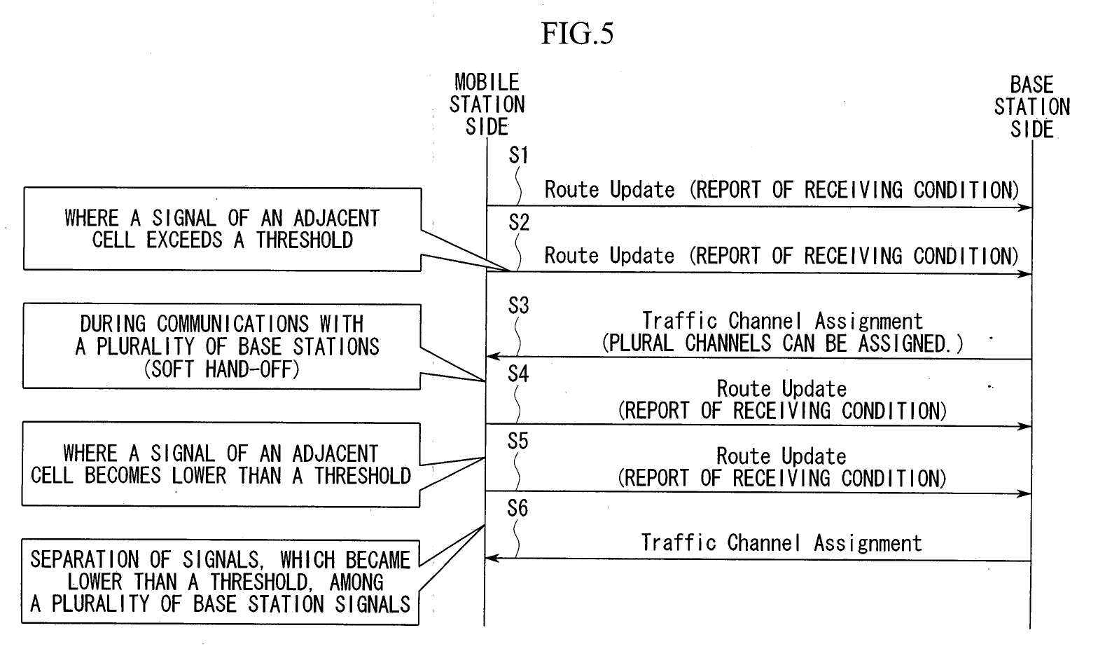

A detailed description is given of processing contents of Step 201 in FIG. 3 by reference to FIG. 4 and FIG. 5.

FIG. 4 shows a state where hand-off is carried out in a mobile communications system according to the present embodiment of the invention, and FIG. 5 shows a control sequence between mobile stations and base stations when carrying out hand-off.

In FIG. 3, it is assumed that mobile stations MS1, MS2 and MS3 are under communications in a cell α of the base station BS1, and mobile stations MS4 and MS5 are under communications in a cell β of the base station BS2.

In the base station BS1, the base station apparatus BTS1 allots a communications resource for the mobile stations MS1, MS2 and MS3, wherein the mobile stations MS1, MS2 and MS3 carry out communications with the communications resource shared to each other. Weighting information for allotment of the communications resource is stored in the AA server via the control station BSC. The inquiry about the weighting information is carried out by the base station apparatus BTS1 which executes allotment of the communications resource to the mobile stations.

Similarly, the mobile stations MS4 and MS5 are under communications in the base station BS2. Weighting for allotment of the communications resource for the mobile stations MS4 and MS5 is carried out by the base station BTS2.

Herein, it is assumed that the mobile station MS3 is moved from the cell α of the base station BS1 to the cell β of the base station BS2. The mobile station MS3 is first under communications with the base station BS1. At this time, the mobile station periodically reports the receiving condition (Sequence S1). However, it monitors receiving signals from the base station BS2.

At the moment when the status of signals from the base station BS2 exceeds a predetermined threshold, the mobile station reports the receiving condition to the base station BS1 (Sequence S2). The reporting is processed by the control station BSC.

The control station BSC requests commencement of communications with the mobile station MS3 of the base station BS2 on the basis of reporting of the receiving condition from the mobile station MS3.

Next, at the moment when the base station apparatus BTS2 is made ready for communications with the mobile station MS3, the control station BSC transmits an alteration instruction of a communications destination to the mobile station MS3 via the base station BS1 (Sequence S3).

Since the mobile station MS3 is wedged into the base station BS2 while the base station BS2 is under communications with the mobile stations MS4 and MS5 at this moment, the communications resource is obliged to be shared by the mobile stations MS3, MS4 and MS5. For this reason, it is necessary for the base station BS2 to acquire the priority information of the mobile station MS3.

Since the priority information is related to MAC-IDs, the control station BSC gives the base station BS2 an instruction for allotment of the MAC-ID having the same priority information as the MAC-ID allotted by the base station BS1.

The base station BS2 acquires information of the mobile station MS3 on the basis of the MAC-ID of the mobile station MS3, and can carry out weighting for allotment of the communications resource. With respect to the alteration instruction in Sequence S3, it is possible to assign communications to both the base station BS1 and base station BS2.

In this case, the mobile station MS3 is made into a status of MS3′. That is, the mobile station MS3 executes communications with the base stations BS1 and BS2 in an area γ in which the cells α and β overlap each other.

The mobile station MS3 reports the receiving condition to the base stations BS1 and BS2 (Sequence S4). In a state where the mobile MS3 is in a state of MS3′, where the signal of the base station BS1 becomes smaller than the threshold, the mobile station MS3 reports the receiving condition to the base station BS1 (Sequence S5).

Herein, it is assumed that the control station BSC terminates communications between the mobile station MS3 and the base station BS1 and determines to cause the mobile station MS3 to commence communications with the base station BS2.

The control station BSC gives the mobile station MS3 an alteration instruction of a communications destination via the base stations BS1 and BS2 (Sequence S6). Thereafter, the base station BS1 terminates communications with the mobile station MS3 and the base station BS2 continues communications with the mobile station MS3.

Thus, when hand-off is carried out, the MAC-ID is taken over from the base station apparatus BTS1 from which a mobile station is handed off to the base station apparatus BTS2 to which the mobile station is handed off.

In the mobile communications system according to the present embodiment of the invention, the MAC-ID can be known at the mobile station side during communications. Therefore, mobile stations can know the communications priority of their own station, which is established by the base station side, without any special process to know the communications priorities.

Accordingly, it may be devised that a mobile station controls the data volume and data transfer rate used for applications in response to the communications priority of its own station.

Also, a mobile station includes information showing situations such as an application used in an access request, and a base station may re-allot an optimal MAC-ID on the basis of the information.

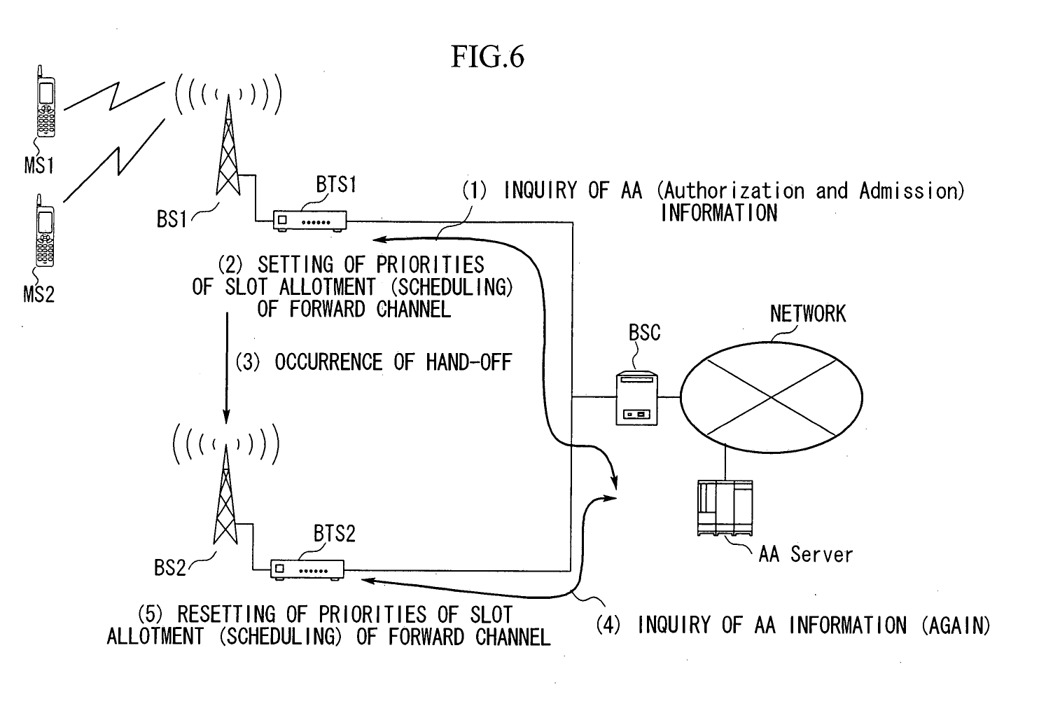

Next, a description is given of actions when carrying out a hand-off in a prior art mobile communications system with reference to FIG. 6. In this example, it is assumed that communications priorities are established in respective mobile stations. In FIG. 6, a mobile station MS1 commences communications and the mobile station MS1 is positioned in a cell of a base station BS1.

A connection request of the mobile station MS1 is transmitted to the control station BSC via a base station apparatus BTS1.

The control station BSC makes an inquiry to an AA (Authorization and Admission) server about whether or not connection to the mobile station MS1 is enabled.

After it is confirmed that the mobile station MS1 is an authentic user, the control station BSC makes an inquiry about the priority information showing the communications priority. The priority information of communications is transmitted from the control station BSC to the base station apparatus BTS1. A connection action is carried out in the mobile station MS2 as well.

Scheduling of communications slots of the mobile stations MS1 and MS2 in the base station apparatus BTS1 is carried out by adding the priority information of mobile stations inquired to the AA server in addition to scheduling on the basis of the receiving quality, which is usually carried out in IS-856. “Adding the priority information” means, for example, multiplying the parameter of the receiving quality by a parameter of the priority, adding the former to the latter, referencing a table, or inserting a value into a function having a plurality of arguments.

It is assumed that the mobile stations MS1 and MS2 are handed off. Where mobile stations are handed off from the base station apparatus BTS1 to the base station apparatus BTS2, information of the mobile stations MS1 and MS2 to be handed off is transferred from the base station apparatus BTS1 to the base station apparatus BTS2 via the control station BSC. At the same time, the base station apparatus BTS2 makes an inquiry to the AA server about the priority information of the mobile stations MS1 and MS2. That is, in the mobile communications system shown in FIG. 6, it is understood that, when mobile stations are being handed off, the data traffic in the base system is further increased in comparison with the case of a mobile communications system according to the present embodiment of the invention, which is shown in FIG. 1.

With the mobile communications system according to the embodiment of the invention, it becomes unnecessary to frequently make an inquiry about priority information showing the communications priorities of mobile stations to an AA server, in which the corresponding priority information is stored, and the data volume between base stations can be reduced.

Further, with the mobile communications system according to the embodiment of the invention, it is possible for the mobile station to know a MAC-ID during communications. Therefore, it is possible for a mobile station to know communications priority of its own station, which is established at the base station side, without carrying out any special process to know the communications priority.

Accordingly, a mobile station is capable of controlling the data volume, which is used in an application, and data transfer rate in accordance with the communications priority of its own station, wherein convenience of a user can be improved.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A dynamic identifier allotting method of dynamically allotting an identifier to a mobile station in an area from a base station, the dynamic identifier allotting method comprising:
controlling a priority in advance corresponding to a fixed identifier of a mobile station;
receiving a fixed identifier of a mobile station from the mobile station to which an identifier is allotted;
determining a priority corresponding to the received fixed identifier; and
allotting an identifier corresponding to the priority of the mobile station to the mobile station.

2. The dynamic identifier allotting method according to claim 1, wherein the fixed identifier of the mobile station is a terminal identifier depending on a mobile station terminal or a subscriber identifier depending on a subscriber.

3. A dynamic identifier allotting method of dynamically allotting an identifier to a mobile station in an area from a base station, the dynamic identifier allotting method comprising:
receiving an access request from the mobile station;
determining a priority corresponding to the received access request; and
allotting an identifier corresponding to the access request to the mobile station.

4. The dynamic identifier allotting method according to claim 3, wherein the priority corresponding to the access request depends on an application which a mobile station terminal uses.

5. A dynamic identifier allotting method of dynamically allotting an identifier to a mobile station in an area from a base station, the dynamic identifier allotting method comprising:
when a mobile station is switched from a base station currently being connected to another base station, receiving an identifier the base station currently being connected has dynamically allotted to the mobile station, by another base station; and
allotting to the mobile station an identifier corresponding to a priority held by the identifier.

6. A wireless communications system comprising:
the control apparatus includes a controlling unit for controlling a priority corresponding to a fixed identifier of the mobile station;
the mobile station includes a transmitting unit for transmitting the fixed identifier of the mobile station to a base station to which the mobile station is connected; and
the base station includes:
a receiving unit for receiving the fixed identifier of the mobile station from the mobile station; and
an allotting unit for allotting to the mobile station an identifier in an area corresponding to the priority of the mobile station based on the received fixed identifier and control information of the controlling unit.

7. The wireless communications system according to claim 6, wherein the fixed identifier of the mobile station is a terminal identifier depending on a mobile station terminal or a subscriber identifier depending on a subscriber.

8. A wireless communications system comprising:
a mobile station includes a transmitting unit for transmitting information showing contents of an access request to a base station to which the mobile station is connected, when making the access request to the base station; and
a base station includes a receiving unit for receiving the access request from the mobile station, and an allotting unit for allotting to the mobile station an identifier in an area corresponding to a priority of the access request based on the information showing contents of the received access request.

9. The wireless communications system according to claim 8, wherein the information showing the contents of the access request is information showing an application which a mobile station terminal uses.

10. A wireless communications system comprising:
when a mobile station is switched from a base station currently being connected to another base station, the mobile station includes a transmitting unit for transmitting an identifier dynamically allotted to the mobile station by the base station currently being connected to another base station; and
another base station includes a receiving unit for receiving the identifier the base station currently being connected has dynamically allotted to the mobile station, and an allotting unit for allotting to the mobile station an identifier corresponding to a priority held by the identifier received by the receiving unit.
